(19) United States
(12) Patent Application Publication
(10) Pub. No.: US 2026/0179590 A1
(43) Pub. Date: Jun. 25, 2026

(54) STAND AND KEYBOARD INSTRUMENT SET

(71) Applicant: CASIO COMPUTER CO., LTD., Tokyo (JP)

(72) Inventors: Naoto IMAMURA, Tokyo (JP); Hiroshi IKEMOTO, Tokyo (JP); Otoya SAKAI, Tokyo (JP)

(73) Assignee: CASIO COMPUTER CO., LTD., Tokyo (JP)

(21) Appl. No.: 19/426,324

(22) Filed: Dec. 19, 2025

(30) Foreign Application Priority Data
Dec. 20, 2024 (JP) 2024-225027
Nov. 12, 2025 (JP) 2025-191747

(51) Int. Cl. G10G 5/00; G10H 1/34

(52) U.S. Cl. CPC G10G 5/005; G10H 1/348; G10H 2220/221; G10H 2220/265

(57) ABSTRACT

A stand includes: a horizontal member; at least one leg that supports a front side of an instrument; and at least one connector that connects the at least one leg to the horizontal member. The at least one connector has two receiving surfaces that cross each other and that are connected to each other. The at least one leg is fixed in a state where the at least one leg is in contact with the two receiving surfaces.

### CROSS-REFERENCE TO RELATED APPLICATIONS

This application is based upon and claims the benefit of priority from the prior Japanese Patent Applications No. 2024-225027, filed on December 20, 2024, and No. 2025-191747, filed on November 12, 2025, the entire contents of which are incorporated herein by reference.

### BACKGROUND OF THE INVENTION

### TECHNICAL FIELD

The present disclosure relates to a stand for a keyboard instrument and a keyboard instrument set including the stand.

### DESCRIPTION OF RELATED ART

A known stand for a keyboard instrument has four legs. For example, according to Japanese Unexamined Patent Application Publication No. 2023-157063, a four-leg stand includes a horizontal member on which the keyboard instrument is placed; connectors provided at both ends of the horizontal member; and front legs and back legs connected to the respective connectors.

### SUMMARY OF THE INVENTION

According to the present disclosure, a stand includes: a horizontal member; at least one leg that supports a front side of an instrument; and at least one connector that connects the at least one leg to the horizontal member, wherein: the at least one connector has two receiving surfaces that cross each other and that are connected to each other, and the at least one leg is fixed in a state where the at least one leg is in contact with the two receiving surfaces.

### BRIEF DESCRIPTION OF DRAWINGS

FIG. 1 is a perspective view of a keyboard instrument set according to an embodiment of the present disclosure.

FIG. 2 is a front view of the keyboard instrument set shown in FIG. 1.

FIG. 3 is a plan view of the keyboard instrument set shown in FIG. 1.

FIG. 4 is a lateral view of the keyboard instrument set shown in FIG. 1.

FIG. 5 is a perspective view of a stand of the keyboard instrument set shown in FIG. 1.

FIG. 6 is a perspective view of the stand of FIG. 5 viewed from diagonally behind and to the right.

FIG. 7 is an enlarged view of main part at the foreground side of the stand in FIG. 6.

FIG. 8 is an exploded perspective view of main part of a connector of the stand in FIG. 7, wherein a leg attachment part and a leg at the connector are enlarged.

FIG. 9 is a perspective view of main part of the connector of the stand in FIG. 7, wherein main part of the leg attachment part is viewed diagonally from the front and right.

### DETAILED DESCRIPTION

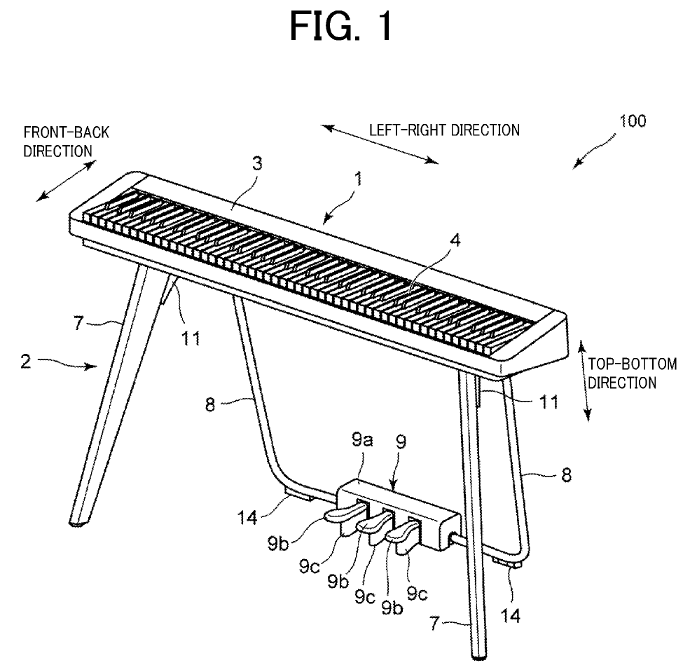

Hereinafter, an embodiment of the present disclosure applied to a keyboard instrument set is described with reference to FIG. 1 to FIG. 9.

A keyboard instrument set 100 includes a keyboard instrument 1 and a stand 2, as shown in FIG. 1 to FIG. 4. The keyboard instrument 1 includes an instrument case 3 that is long in the widthwise direction (left-right direction). The instrument case 3 is provided with a keyboard 4. The keyboard 4 includes multiple white keys and black keys arranged in the long-side direction (left-right direction).

In the present disclosure, the left-right direction refers to the direction to the left and to the right of a position where a player stands in playing the keyboard instrument 1. Regarding the top-bottom direction (up-down direction), the top surface of the keyboard instrument 1 is defined as the surface on which the keyboard 4 is provided; and the bottom surface of the keyboard instrument 1 is defined as the surface opposite the top surface. Regarding the front-back direction, the front side is the player's side, and the back side is the side opposite the front side.

As shown in FIG. 1 to FIG. 5, the stand 2 includes a horizontal member 5, two connectors 6, two legs 7, a pedal frame 8, and a pedal device 9. The horizontal member 5 has a rectangular tubular shape that is long in the widthwise direction (left-right direction). The keyboard instrument 1 is placed on the horizontal member 5. The two connectors 6 are provided at both ends in the widthwise direction (left-right direction) of the horizontal member 5. The two legs 7 are attached to the respective connectors 6 and support the front side of the keyboard instrument 1. The pedal frame 8 is attached to the connectors 6 at both sides and supports the back side of the keyboard instrument 1. The pedal device 9 is fixed to the pedal frame 8.

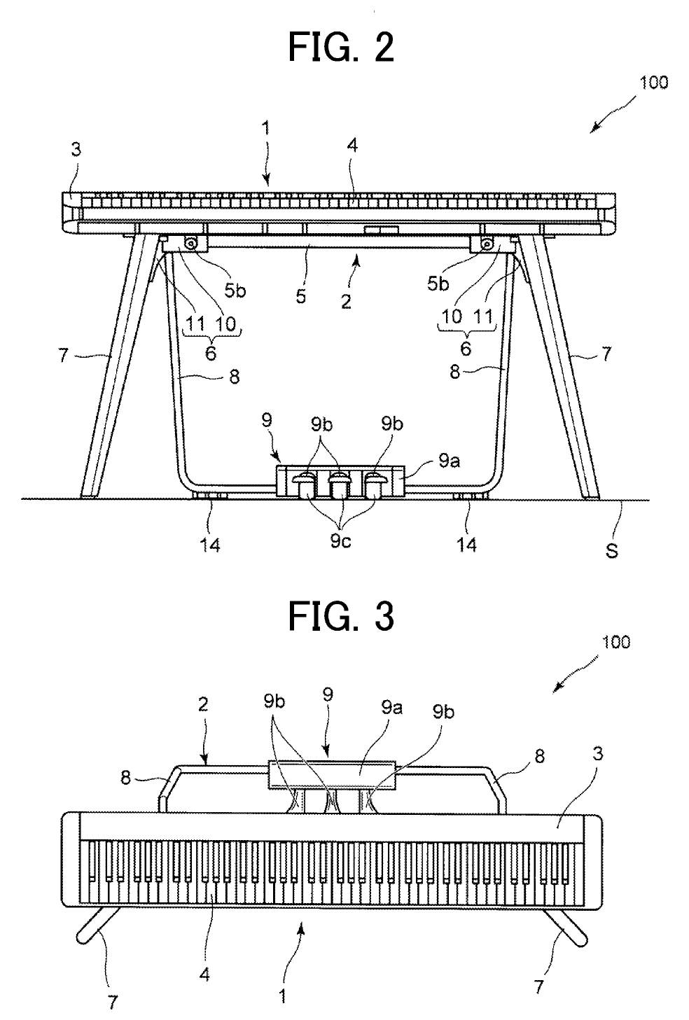

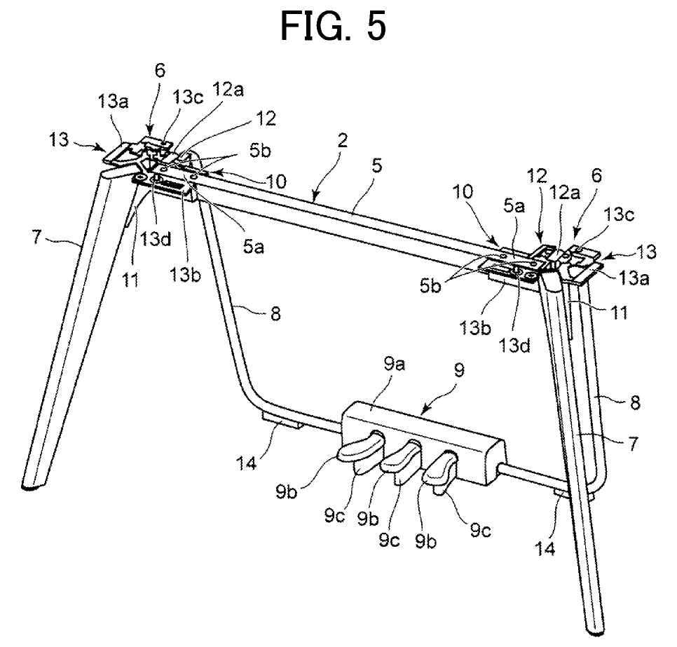

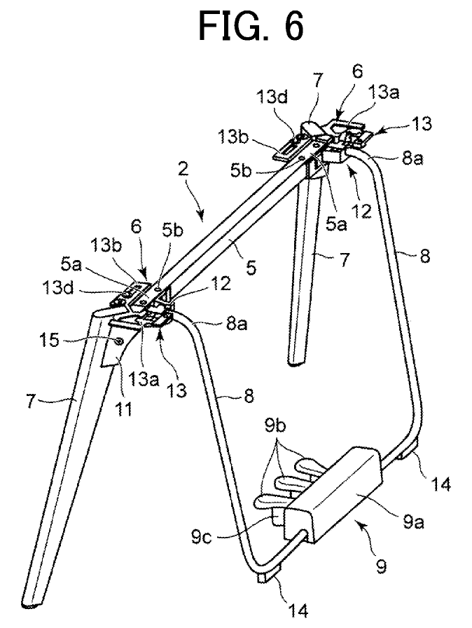

As shown in FIG. 5 to FIG. 9, each of the two connectors 6 includes: a horizontal-member attachment part 10 to which an end part 5a in the left-right direction of the horizontal member 5 is attached; a leg attachment part 11 (first engaging part) to which the upper part of the leg 7 is attached; a frame attachment part 12 (frame fixing part) to which the upper end part of the pedal frame 8 is attached; and an instrument setting part 13 that determines the position of the bottom surface of the keyboard instrument 1 and on which the keyboard instrument 1 is mounted. The end parts 5a in the widthwise (left-right) direction of the horizontal member 5 are inserted into the respective horizontal-member attachment parts 10 from above, and multiple screws 5b (see FIG. 2 and FIG. 6) are screwed on the top surface, the bottom surface, and the lateral surfaces of the end parts 5a. Thus, the horizontal-member attachment parts 10 are attached to the horizontal member 5.

The leg attachment parts 11 are L-shaped, as illustrated in FIG. 5 to FIG. 9. Each of the leg attachment parts 11 includes a first receiving surface 11a and a second receiving surface 11b that are perpendicular to each other. The leg 7 is attached to the first receiving surface 11a and the second receiving surface 11b. The first receiving surface 11a of the leg attachment part 11 extends diagonally downward from the inside to the outside of the keyboard instrument 1. The second receiving surface 11b of the leg attachment part 11 extends diagonally downward and forward in the front-back direction (short-side direction) of the keyboard instrument 1. The first receiving surface 11a may not be perpendicular to the second receiving surface 11b. The present disclosure also includes a case where the first receiving surface 11a simply crosses the second receiving surface 11b.

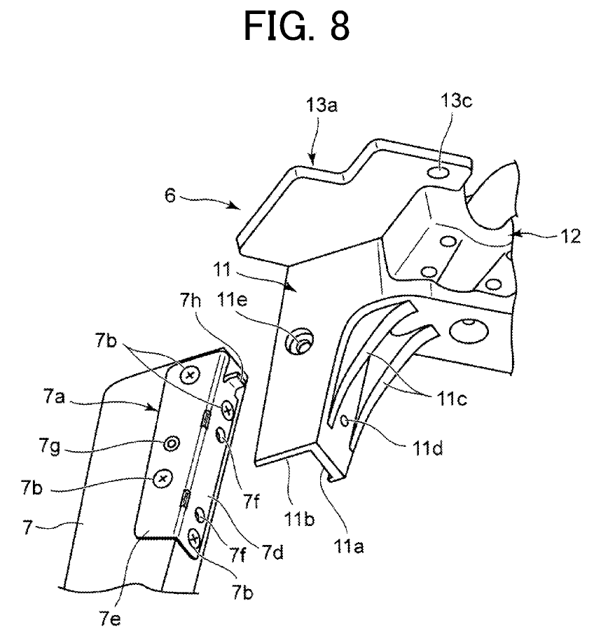

In this case, an external surface opposite the first receiving surface 11a of the leg attachment part 11 has ribs 11c along the top-bottom direction, as illustrated in FIG. 8. The ribs 11c are reinforcement members. At the upper and lower parts of the first receiving surface 11a (only the lower part is illustrated in FIG. 8), first attachment holes 11d are formed between the ribs 11c as the reinforcement members. At the central part in the top-bottom direction of the second receiving surface 11b, a second attachment hole 11e is formed. An upper corner of each of the legs 7 is provided with an L-shaped reinforcement metal part 7a (second engaging part). The reinforcement metal part 7a is attached to the upper corner of the leg 7 by screws 7b. The reinforcement metal part 7a faces the first receiving surface 11a and the second receiving surface 11b, which are perpendicular to each other, of the leg attachment part 11. The reinforcement members are not limited to ribs. Any member having the reinforcement effect is applicable, such as a stay, a bracket, or a stiffener.

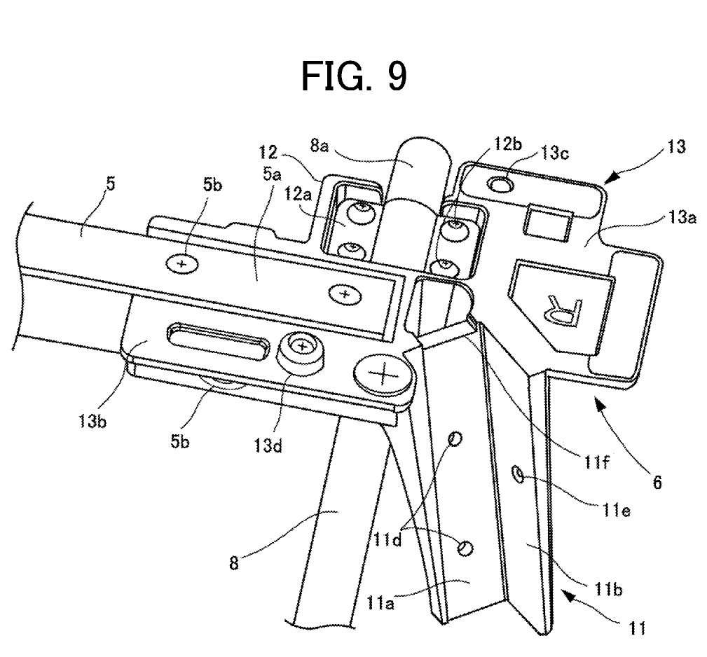

The reinforcement metal part 7a has a first attachment surface 7d and a second attachment surface 7e, as illustrated in FIG. 8. The first attachment surface 7d faces the first receiving surface 11a of the leg attachment part 11, and the second attachment surface 7e faces the second receiving surface 11b of the leg attachment part 11. The first attachment surface 7d of the reinforcement metal part 7a has two first screw holes 7f at the upper and lower parts. The two first screw holes 7f correspond to the two first attachment holes 11d of the first receiving surface 11a of the leg attachment part 11. The upper end part of the first attachment surface 7d of the reinforcement metal part 7a has an engaging protrusion 7h that engages with an engaging recess 11f (see FIG. 9) formed in the first receiving surface 11a of the leg attachment part 11. The second attachment surface 7e of the reinforcement metal part 7a has a second screw hole 7g. The second screw hole 7g corresponds to the second attachment hole 11e of the second receiving surface 11b of the leg attachment part 11.

As illustrated in FIG. 8, when the reinforcement metal part 7a at the upper part of each leg 7 is arranged inside the leg attachment part 11 of the connector 6, the first attachment surface 7d and the second attachment surface 7e of the reinforcement metal part 7a, which are perpendicular to each other, face the first receiving surface 11a and the second receiving surface 11b of the leg attachment part 11, which are perpendicular to each other. Thus, the reinforcement metal part 7a is covered by the first receiving surface 11a and the second receiving surface 11b, which are perpendicular to each other, of the leg attachment part 11 of the connector 6. The reinforcement metal part 7a is therefore hidden and invisible from outside. Since the screws 7b are covered, deterioration in design can be restrained. For example, according to the four-leg stand described in JP2023-157063, the stand cannot secure sufficient strength if the front legs and the back legs are simply attached to the connectors. Therefore, the stand of JP2023-157063 requires a connection metal part that connects the front legs and the back legs. Such an exposed and conspicuous connection metal part deteriorates the design. According to the present disclosure, the stand secures sufficient strength while restraining deterioration in design.

In this case, the two first screw holes 7f of the reinforcement metal part 7a correspond to the two first attachment holes 11d (see FIG. 9) of the first receiving surface 11a; and the second screw hole 7g of the reinforcement metal part 7a corresponds to the second attachment hole 11e of the second receiving surface 11b. The engaging protrusion 7h of the reinforcement metal part 7a is placed on the engaging recess 11f of the first receiving surface 11a and thereby engages with the engaging recess 11f. The first receiving surface 11a and the second receiving surface 11b are disposed at the lateral side and the back side of the leg 7 so as to be invisible from the front side.

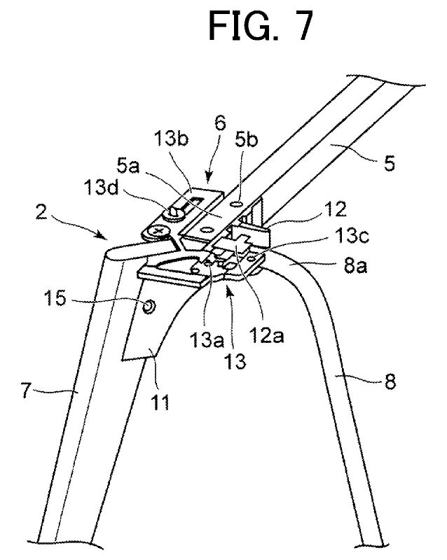

As illustrated in FIG. 7 and FIG. 8, according to the leg 7, two screws as fastening members (not illustrated) are inserted through the first attachment holes 11d of the first receiving surface 11a and screwed to the two first screw holes 7f of the first attachment surface 7d of the reinforcement metal part 7a; and the other screw 15 (see FIG. 7) is inserted through the second attachment hole 11e of the second receiving surface 11b and screwed to the second screw hole 7g of the second attachment surface 7e of the reinforcement metal part 7a. Thus, the non-illustrated two screws and the other screw 15 are screwed to the reinforcement metal part 7a of the leg 7, so that the leg 7 is attached to the leg attachment part 11 of the connector 6.

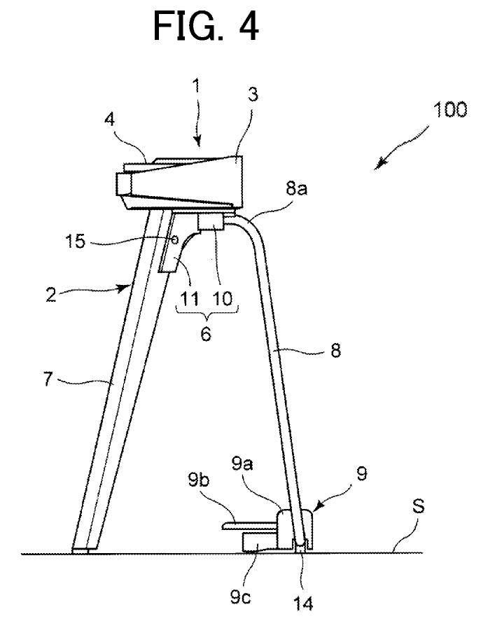

As illustrated in FIG. 5 to FIG. 8, the two legs 7 are attached to the leg attachment parts 11 of the connectors 6, which are provided at both ends of the horizontal member 5, by the non-illustrated two screws and the other screw 15. Accordingly, as illustrated in FIG. 3 and FIG. 4, the legs 7 extend diagonally downward, outward, and forward in the front-back direction (short-side direction) of the keyboard instrument 1. Thus, the legs 7 spread outward and forward with respect to the keyboard instrument 1.

The frame attachment part 12 of the connector 6 includes a pressing metal part 12a that presses and fixes the upper end of the pedal frame 8, as illustrated in FIG. 5 to FIG. 7 and FIG. 9. The pressing metal part 12a is attached to the frame attachment part 12 with screws 12b in the state where the pressing metal part 12a positions and presses the upper end of the pedal frame 8 with respect to the frame attachment part 12. In this case, the pedal frame 8 consists of two large bars. In a front view of the keyboard instrument 1 as illustrated in FIG. 2, the two bars of the pedal frame 8 extend upward from both ends in the long-side direction of the pedal device 9 so as to form a substantially inverted trapezoid shape. As illustrated in FIG. 3 and FIG. 4, the pedal frame 8 is disposed behind the legs 7 and extends diagonally downward and backward in the front-back (short-side) direction of the keyboard instrument 1.

As illustrated in FIG. 2, the width of the pedal frame 8 in the long-side direction of the keyboard instrument 1 is slightly shorter than the width of the legs 7. Further, the pedal frame 8 is provided with non-slip members 14 at two positions at both sides in the left-right direction (long-side direction) of the pedal device 9. The non-slip members 14 are in contact with the installation surface S on which the stand 2 is installed and prevents the stand 2 from slipping.

As illustrated in FIG. 1 to FIG. 5, the pedal device 9 includes: a box-shaped device body 9a that is long in the widthwise (long-side) direction of the keyboard instrument 1; and three pedals 9b that are arranged in the widthwise (long-side) direction of the device body 9a and project forward from the device body 9a. Below the respective three pedals 9b, projections 9c are provided that extend forward from the device body 9a. The projections 9c are provided with a non-illustrated installation adjustment member that adjusts the contact with the installation surface S.

The instrument setting parts 13 of the two connectors 6, on which the keyboard instrument 1 is mounted, each include: a front setting part 13a that extends toward the front side of the keyboard instrument 1; and a lateral setting part 13b that extends in the widthwise (long-side) direction of the keyboard instrument 1, as illustrated in FIG. 5 to FIG. 9. The two front setting parts 13a each have a fixing hole 13c for screwing the bottom surface at the end of the keyboard instrument 1 in the long-side direction. The two lateral setting parts 13b each have a positioning pin 13d for positioning the bottom surface of the keyboard instrument 1. When viewed from above, the edge of each front setting part 13a is positioned slightly inside the top end of the leg 7 with respect to the keyboard instrument 1. Thus, the keyboard instrument 1 is mounted on the stand 2 more stably.

Hereinafter, how to assembly the keyboard instrument set 100 is described. Firstly, the stand 2 is assembled. The connectors 6 are attached to both end parts in the widthwise (left-right) direction of the horizontal member 5. Specifically, the end parts 5a at both ends of the horizontal member 5 are fitted to the horizontal-member attachment parts 10 of the respective two connectors 6 from above. Then, screws 5b are screwed to the upper surface, the bottom surface, and the lateral surfaces of the end parts 5a at both ends of the horizontal member 5. Thus, the connectors 6 are attached to the horizontal member 5. In this state, the pedal frame 8 is attached to the frame attachment parts 12 of the connectors 6, which have been attached to the horizontal member 5.

Herein, the pedal device 9 has been attached to the pedal frame 8 beforehand; and the non-slip members 14 have been attached to both side parts of the pedal frame 8 at both sides of the pedal device 9 beforehand. The pedal frame 8 is then laid on the installation surface S (e.g., floor) such that the upper ends 8a at both ends of the pedal frame 8 face upward. In this state, the frame attachment parts 12 of the two connectors 6 are attached to the upper ends 8a at both ends of the pedal frame 8. Herein, the upper ends 8a of the pedal frame 8 are positioned with respect to the frame attachment parts 12 of the connectors 6 and pressed with the pressing metal parts 12a. In this state, the pressing metal parts 12a are attached to the frame attachment parts 12 with the screws 12b.

When the horizontal member 5 is attached to the pedal frame 8 via the two connectors 6 in the state where the pedal frame 8 is laid on the installation surface S (e.g., floor), the leg attachment parts 11 of the two connectors 6 tilt diagonally upward. In this state, the legs 7 are attached to the leg attachment parts 11 of the respective two connectors 6, which have been attached to both ends of the horizontal member 5. Herein, the L-shaped reinforcement metal parts 7a have been attached to the upper corners of the respective legs 7 with screws 7b beforehand.

In this state, the engaging protrusion 7h of the L-shaped reinforcement metal part 7a, which has been attached to the upper part of each leg 7 beforehand, is placed on and engages with the engaging recess 11f of the first receiving surface 11a, so that the position of the reinforcement metal part 7a is substantially determined. In this state, the reinforcement metal part 7a is positioned inside the L-shaped leg attachment part 11 of the connector 6. Accordingly, the first attachment surface 7d and the second attachment surface 7e of the reinforcement metal part 7a, which are perpendicular to each other, face the first receiving surface 11a and the second receiving surface 11b of the leg attachment part 11, which are perpendicular to each other. In this state, the two first screw holes 7f of the reinforcement metal part 7a correspond to the two first attachment holes 11d of the first receiving surface 11a; and the second screw hole 7g of the reinforcement metal part 7a corresponds to the second attachment hole 11e of the second receiving surface 11b. Thus, the reinforcement metal part 7a is covered by the first receiving surface 11a and the second receiving surface 11b (perpendicular to each other) of the leg attachment part 11 of the connector 6, thereby being hidden and invisible from outside.

Then, non-illustrated two screws (fastening members) are inserted through the first attachment holes 11d of the first receiving surface 11a and screwed into the two first screw holes 7f formed on the first attachment surface 7d of the reinforcement metal part 7a. Further, the other screw 15 is inserted through the second attachment hole 11e of the second receiving surface 11b and screwed into the second screw hole 7g. By screwing the non-illustrated two screws and the other screw 15, the leg 7 is attached to the leg attachment part 11 of the connector 6. Thus, the stand 2, which supports the front and the back of the keyboard instrument 1 by the two legs 7 and the pedal frame 8, is assembled.

In this state, the stand 2 is erected on the installation surface S (e.g., floor) with the two legs 7 and the pedal frame 8. As shown in FIG. 3 and FIG. 4, the two legs 7 extend downward in the outward direction of the keyboard instrument 1 and the forward direction in the front-back (short-side) direction of the keyboard instrument 1. Thus, the legs 7 spreads outward and forward with respect to the keyboard instrument 1. Thus, the two legs 7 spread diagonally forward with respect to the keyboard instrument 1 and support the front side of the keyboard instrument 1. Herein, the pedal frame 8, which consists of two bars, is arranged behind the legs 7, spreads backward with respect to the keyboard instrument 1, and supports the back side of the keyboard instrument 1.

Both ends of the bottom surface of the keyboard instrument 1 in the left-right (long-side) direction are placed on the instrument setting parts 13 of the two connectors 6 of the stand 2. The positions of both ends of the bottom surface of the keyboard instrument 1 in the left-right direction are determined by the positioning pins 13d provided to the lateral setting parts 13b of the respective two instrument setting parts 13. In this state, non-illustrated screws are inserted through the fixing holes 13c of the respective two front setting parts 13a from below the keyboard instrument 1 and screwed into the bottom surface of the keyboard instrument 1. Thus, the keyboard instrument 1 is attached to the stand 2. In this state, the contact state of the pedal device 9 with respect to the installation surface S is adjusted by a non-illustrated installation adjustment member of the pedal device 9. Thus, the keyboard instrument set 100 is assembled.

As described above, the stand 2 of the keyboard instrument set 100 includes: the horizontal member 5; the legs 7 that support the front side of the keyboard instrument 1; and the connectors 6 that connect the legs 7 to the horizontal member 5. Each of the connectors 6 includes two receiving surfaces: the first receiving surface 11a and the second receiving surface 11b that are perpendicular to each other. Each of the legs 7 is fixed to the connector 6 in the state of being in contact with the first receiving surface 11a and the second receiving surface 11b. Such a stand 2 secures sufficient strength and prevents deterioration in design.

According to the stand 2 of the keyboard instrument set 100, since each leg 7 is fixed to the connector 6 in the state of being in contact with the first receiving surface 11a and the second receiving surface 11b, the leg 7 is fixed to the connector 6 in two directions perpendicular to each other. Thus, the leg 7 can be certainly and firmly fixed to the connector 6 without using a conspicuous connection metal part or the like. Such a stand 2 increases the attachment strength of the leg 7 to the connector 6 and prevents deterioration in design.

In this case, the stand 2 of the keyboard instrument set 100 includes the pedal frame 8, the pedal device 9 fixed to the pedal frame 8, and the frame attachment parts 12 as frame fixing parts that fix the pedal frame 8. By attaching the frame attachment parts 12 to the connectors 6, the pedal frame 8 can be used as a back-side leg. This eliminates the need for back-side legs as separate parts and reduces the number of parts, thereby simplifying the structure and assembly work. Accordingly, productivity is increased.

Further, according to the stand 2 of the keyboard instrument set 100, each connector 6 includes the leg attachment part 11 as a first engaging part. Each leg 7 is provided with the reinforcement metal part 7a as a second engaging part. The reinforcement metal part 7a is covered by and fixed to the leg attachment part 11. According to such a structure, the leg 7 can be certainly and firmly attached to the leg attachment part with the reinforcement metal part 7a. Further, the reinforcement metal part 7a provided to the leg 7 is covered by the leg attachment part 11 of the connector 6 so as to be invisible from outside. Thus, deterioration in design can be restrained.

Further, the reinforcement metal part 7a as the second engaging part includes the engaging protrusion 7h. The leg attachment part 11 as the first engaging part includes the engaging recess 11f. When the engaging protrusion 7h engages with the engaging recess 11f, the first screw holes 7f and the second screw hole 7g are positioned so as to correspond to the first attachment holes 11d and the second attachment hole 11e, respectively, before the reinforcement metal part 7a is attached to the leg attachment part 11. Thus, the leg 7 can be attached easily.

The reinforcement metal part 7a as the second engaging part is attached to the leg 7 by the screws 7b. The reinforcement metal part 7a is covered by and fixed to the leg attachment part 11. Since the screws 7b are covered by the leg attachment part 11 of the connector 6 and invisible from outside, deterioration in design can be restrained.

Further, on the external surface at the opposite of the first receiving surface 11a to which the leg 7 is attached, two ribs 11c as reinforcement members are formed in the top-bottom direction. The two ribs 11c (reinforcement members) are formed at both sides in the left-right direction of the first attachment holes 11d of the first receiving surface 11a. Such ribs 11c can reinforce the first receiving surface 11a, the strength of which has been decreased by the holes. Since two ribs 11c are provided, the reinforcement effect is further secured.

Further, according to the stand 2 of the keyboard instrument set 100, the reinforcement metal part 7a as the second engaging part has two surfaces that cross each other. With the reinforcement metal part 7a having two surfaces, the leg 7 can be fixed to the connector 6 in two orthogonal directions. Accordingly, the leg 7 is certainly and firmly fixed to the connector 6, and the attachment strength of the leg 7 to the connector 6 can be improved.

Further, the two instrument setting parts 13 on which the keyboard instrument 1 is mounted are disposed above the first receiving surface 11a and the second receiving surface 11b, which cross each other, of the connector 6. Each instrument setting part 13 includes the front setting part 13a that extends in the short-side direction of the keyboard instrument 1. When viewed from above, the edge of the front setting part 13 is positioned slightly inside the top end of the leg 7 in the long-side direction of the keyboard instrument 1. Thus, the weight of the keyboard instrument 1 is dispersed by the front setting parts 13a, so that the keyboard instrument 1 can be more stably mounted on the stand 2.

In the above-described embodiment, the pedal frame 8 has a substantially inverted trapezoid shape. However, the present disclosure is not limited to this. The pedal frame 8 may have a square or rectangular shape, for example.

In the above embodiment, the stand 2 is applied to the keyboard instrument 1. The present disclosure is not only for the keyboard instrument 1 but is also applicable to a koto (zither-like Japanese musical instrument), a dulcimer, a DJ controller, or a MIDI controller, for example.

1. A stand comprising:
a horizontal member;
at least one leg that supports a front side of an instrument; and
at least one connector that connects the at least one leg to the horizontal member, wherein:
the at least one connector has two receiving surfaces that cross each other and that are connected to each other, and
the at least one leg is fixed in a state where the at least one leg is in contact with the two receiving surfaces.

2. The stand according to claim 1, wherein the at least one connector includes at least one reinforcement member at a position corresponding to the at least one leg.

3. The stand according to claim 2, wherein:
the at least one reinforcement member includes at least one rib, and
the at least one rib is formed along a top-bottom direction on an external surface of the at least one connector, the external surface being at an other side of the receiving surfaces.

4. The stand according to claim 2, wherein:
the at least one connector includes an attachment hole, and
the at least one reinforcement member includes two reinforcement members provided at both sides of the attachment hole.

5. The stand according to claim 1, wherein:
the at least one connector includes a first engaging part,
a second engaging part is attached to the at least one leg, and
the second engaging part is covered by and fixed to the first engaging part.

6. The stand according to claim 5, wherein:
the first engaging part includes an engaging recess,
the second engaging part includes an engaging protrusion, and
the engaging protrusion engages with the engaging recess.

7. The stand according to claim 5, wherein:
the second engaging part includes at least one screw, and
the first engaging part covers the second engaging part and the at least one screw.

8. The stand according to claim 5, wherein the second engaging part has two surfaces that cross each other and that are connected to each other.

9. The stand according to claim 1, wherein:
the at least one connector includes a front setting part that is disposed above the two receiving surfaces that cross each other, and
the instrument is to be mounted on the front setting part.

10. The stand according to claim 9, wherein in a top view in a top-bottom direction of the instrument, an edge of the front setting part is positioned inside a top end of the at least one leg.

11. The stand according to claim 1, wherein the instrument is a keyboard instrument.

12. The stand according to claim 11, further comprising:
a pedal frame; and
a pedal device fixed to the pedal frame,
wherein the at least one connector includes a frame fixing part that fixes the pedal frame.

13. A keyboard instrument set comprising the stand according to claim 1.
